(19) United States
(12) Patent Application Publication
(10) Pub. No.: US 2025/0304195 A1
(43) Pub. Date: Oct. 2, 2025

(54) BIAXIALLY EXTENSIBLE AND RETRACTABLE WHEEL-LEG MECHANISM, AND VEHICLE COMPRISING SUCH A WHEEL-LEG MECHANISM

(71) Applicant: Schaeffler Technologies AG & Co. KG, Herzogenaurach (DE)

(72) Inventors: Jingyuan Tan, Singapore (SG); Jannick Altherr, Bühl (DE)

(73) Assignee: Schaeffler Technologies AG & Co. KG, Herzogenaurach (DE)

(21) Appl. No.: 18/864,522

(22) PCT Filed: Apr. 17, 2023
(86) PCT No.: PCT/DE2023/100277

§ 371 Date: Nov. 9, 2024

(30) Foreign Application Priority Data
May 10, 2022 (DE) 10 2022 111 563.1

(51) Int. Cl. B62D 57/028; B60G 3/18; B60K 7/00; B60T 1/02; B62D 9/00

(52) U.S. Cl. CPC B62D 57/028; B60K 7/0007; B62D 9/00; B60G 3/18; B60T 1/02

(57) ABSTRACT

A biaxially extensible and retractable wheel-leg mechanism for a vehicle includes a pantograph coupling limb assembly with a plurality of coupling limbs which are coupled together in an articulated manner. A wheel hub motor and a steering actuator operatively connected thereto are arranged on a first coupling limb, and the wheel hub motor is designed to rotate a vehicle wheel drivingly connected to the wheel hub motor. The steering actuator is designed to set a steering angle of the wheel of the vehicle. The wheel-leg mechanism additionally comprises a rotary drive for positioning the coupling limb, said rotary drive being drivingly arranged on a first joint between a second coupling limb and a third coupling limb. The rotary drive is designed to set a relative angular position between the coupling limbs coupled together in an articulated manner such that the position of the wheel hub motor relative to the rotary drive can be adjusted in the longitudinal direction and/or in the vertical direction of the vehicle.

### CROSS-REFERENCE TO RELATED APPLICATIONS

This application is the U.S. National Phase of PCT Appln. No. PCT/DE2023/100277 filed Apr. 17, 2023, which claims priority to DE 10 2022 111 563.1 filed May 10, 2022, the entire disclosures of which are incorporated by reference herein.

### TECHNICAL FIELD

The disclosure relates to a biaxially extensible and retractable wheel-leg mechanism and a vehicle comprising such a wheel-leg mechanism.

### BACKGROUND

US 2021/122030 A1 discloses a bionic robot comprising a body and a plurality of sets of wheeled leg assemblies arranged at intervals in a front-to-back direction, each set of wheeled leg assemblies comprising two wheeled leg assemblies arranged symmetrically in a left-to-right direction. The two wheeled leg assemblies are arranged on left and right sides of the body, each wheeled leg assembly comprising a leg assembly and an impeller. A power output shaft of the leg assembly is connected to the impeller to drive the impeller. The robot further comprises a suspension device disposed in the body and connected to at least two sets of the plurality of sets of wheeled leg devices, wherein the at least two sets of wheeled leg devices are arranged at the frontmost end and at the rearmost end, respectively. The suspension device comprises a plurality of drive assemblies, each drive assembly being connected to a corresponding leg assembly for driving the leg assembly to be raised or depressed. Each drive assembly comprises an electric cylinder and a telescopic rod arranged on the electric cylinder, wherein the electric cylinder is configured to drive the telescopic rod to extend or retract.

### SUMMARY

The object of the present disclosure is to propose a novel, biaxially extensible and retractable wheel-leg mechanism and a vehicle comprising at least one such wheel-leg mechanism. This object is achieved by a wheel-leg mechanism and by a vehicle having the features of described herein. Preferred or advantageous embodiments of the disclosure are described in the claims, the following description, and the attached figures.

An inventive biaxially extensible and retractable wheel-leg mechanism for a vehicle according to a first aspect of the disclosure comprises a pantograph coupling limb assembly with multiple coupling limbs which are coupled together in an articulated manner, wherein a wheel hub motor and a steering actuator operatively connected thereto are arranged on a first coupling limb, and the wheel hub motor is designed to rotate a vehicle wheel drivingly connected to the wheel hub motor, and wherein the steering actuator is designed to set a steering angle of the wheel of the vehicle, the wheel-leg mechanism additionally comprising a rotary drive for positioning the coupling limbs, said rotary drive being drivingly arranged on a first joint between a second coupling limb and a third coupling limb, wherein the rotary drive is designed to set a relative angular position between the coupling limbs coupled together in an articulated manner such that a position of the wheel hub motor relative to the rotary drive can be adjusted in the longitudinal direction and/or in the vertical direction of the vehicle.

The specific arrangement of the coupling limbs of the pantograph coupling limb assembly and the connection of the rotary drive to the pantograph coupling limb assembly enable the wheel hub motor to be moved along a dependent trajectory which, depending on the direction of rotation of the rotary drive, enables adjustment of the wheel hub motor relative to the rotary drive in the longitudinal direction and/or in the vertical direction of the vehicle. Thus, the wheel hub motor can be biaxially extended and retracted relative to the rotary drive and thus relative to the chassis of the vehicle in order to be able to carry out vehicle-specific functions that require the position of the wheel hub motor to be at least temporarily adjusted relative to the rotary drive or the chassis. Such functions may, for example, be climbing up or down a level and/or cornering. This trajectory of the wheel hub motor can substantially have the shape of a circle or an oval. It is also conceivable that the trajectory of the wheel hub motor substantially has the shape of a triangle or a square, in particular with rounded corners. The shape of the trajectory depends on the geometry of the pantograph coupling limb assembly as well as on the location and angular position of the connection of the rotary drive to the pantograph coupling limb assembly. The pantograph coupling limb assembly preferably produces a rectangular trajectory in the form of a rounded rectangle on the contact surface of the respective wheel of the vehicle. Such a wheel-leg mechanism enables asynchronous extension and retraction in the vertical direction and/or longitudinal direction of the vehicle.

The first joint, at which the rotary drive is coupled to the pantograph coupling limb assembly, is to be understood as the actuating joint of the pantograph coupling limb assembly or the wheel-leg mechanism, via which the coupling limbs of the pantograph coupling limb assembly are adjusted relative to one another. By adjusting the coupling limbs, the aforementioned positioning of the wheel hub motor relative to the rotary drive is achieved along the defined trajectory. Advantageously, only a single rotary drive is required to adjust the wheel hub motor relative to the rotary drive.

The rotary drive is designed in such a way that a position control of the pantograph coupling limb assembly, in particular of the coupling limbs, can be carried out. For this purpose, the rotary drive is preferably connected to a control device which can monitor a rotary angle position of a drive shaft, in particular a rotor shaft, of the rotary drive. The rotary angle position of the drive shaft in combination with the specific geometry of the pantograph coupling limb assembly provides the control device with information about the position of each individual coupling limb and ultimately about the position of the wheel hub motor relative to the rotary drive in the longitudinal direction and/or in the vertical direction of the vehicle. On the one hand, the rotary drive controls the movement of the coupling limbs and, on the other hand, it can at least indirectly monitor the coupling limb and/or wheel hub motor positions. A three-stage brushless planetary gear motor with a torque sensor is suitable as a rotary drive, as such a drive is compact and enables high torque output with precise position control. However, the wheel-leg mechanism is not limited to this particular gear motor, but to all gear motors that are compact and provide high torque output with precise position control.

The wheel hub motor is part of an electric hub motor that can be used to drive or support the vehicle. The hub motor can be connected to the above-mentioned control device to control the drive of the vehicle. The control device can therefore fulfil multiple functions. The wheel hub motor comprising the hub motor is preferably a brushless motor which is arranged on the first coupling limb. The wheel hub motor is preferably arranged spatially within an associated wheel of the vehicle and can be connected to a tire of the vehicle directly or via a rim.

The steering actuator, which is attached together with the wheel hub motor to the end of the first coupling limb of the coupling limb assembly, is intended to adjust a steering angle of the wheel hub motor in order to be able to navigate the vehicle during operation. By means of the steering actuator, a holonomic movement of the vehicle can be realized. The steering actuator is designed so that a high torque can be set for steering. The steering actuator can be connected to the hub motor directly or via a gear.

The terms “operatively connected” or “drivingly connected” are to be understood as meaning that an output shaft of the steering actuator can be directly connected to the wheel hub motor of the wheel-leg mechanism, or that further elements, in particular transmission elements, for example one or more shafts or gears, gear stages, or the like, can be located between the output of the steering actuator and the wheel hub motor.

The coupling limbs are preferably rod-shaped or tubular elements which are connected to one another in an articulated manner, for example via shoulder bolts, lock nuts, screws, flange bushings or the like. Shoulder bolts and lock nuts hold the limbs in their position and together with the joints form an assembly, namely the pantograph coupling limb assembly of the wheel-leg mechanism. The coupling limbs rotate against each other smoothly or with minimal friction via the respective articulated connection. The fasteners are selected in such a way that frictional losses are kept to a minimum. This allows the rotary drive to be designed to be comparatively small and compact.

The pantograph coupling limb assembly enables the proposed wheel-leg mechanism to generate a gear trajectory, hereinafter also referred to as trajectory, so that the proposed wheel-leg mechanism can extend and retract asynchronously in both the vertical and longitudinal axes of the vehicle. For example, vehicles, in particular autonomously driving robots, equipped with a proposed wheel-leg mechanism or multiple wheel-leg mechanisms can climb steps, adjust a platform or chassis height, variably adjust the length of a wheelbase and/or stabilize or tilt the platform or chassis such that any wobbling of the platform or chassis when cornering is compensated. In addition, the size and shape of the trajectory of the wheel-leg mechanism can be changed by changing the length of the coupling limbs and/or the position of the joints relative to each other.

Preferably, the pantograph coupling limb assembly comprises at least four coupling limbs, wherein the first coupling limb is articulatedly coupled to the second coupling limb and a fourth coupling limb, and wherein the third coupling limb is articulatedly coupled to the second and fourth coupling limbs. In other words, both the first coupling limb and the third coupling limb are articulatedly connected to the second coupling limb and to the fourth coupling limb. For the desired functionality of the wheel-leg mechanism, it is sufficient if the pantograph coupling limb assembly has exactly four coupling limbs, with each coupling limb being articulatedly connected to exactly two other coupling limbs.

According to one exemplary embodiment, the pantograph coupling limb assembly has six coupling limbs. The fifth and/or sixth coupling limb can be designed as a mirror image of the first and third coupling limb or of the second and fourth coupling limb. This allows the pantograph coupling limb assembly to be made more stable.

Preferably, the wheel-leg mechanism further preferably comprises a chassis bracket which is arranged on the fourth coupling limb and is designed to fasten the wheel-leg mechanism to a chassis of the vehicle. The chassis bracket can be designed such that the wheel-leg mechanism can be screwed and/or riveted to the chassis or platform of the vehicle.

The wheel hub motor and the steering actuator are preferably connected to each other via a stator element which is mounted radially and axially on the first coupling limb via a bearing element. The stator element is to be understood as a support or fork that creates a rigid connection between the steering actuator and the wheel hub motor. The stator element is held at the end of the first coupling limb of the pantograph coupling limb assembly by the bearing element. Preferably, the bearing element is a double-row angular contact ball bearing. The wheel hub motor is preferably arranged substantially vertically below the steering actuator and connected to it via the stator element. The stator element is arranged to be rotatable about its longitudinal axis by the steering actuator. The bearing element supports the stator element axially and radially on the pantograph coupling limb assembly.

Furthermore, a brake is preferably arranged on the wheel hub motor. The brake comprises a brake caliper with rotor. The brake caliper with rotor provides the necessary mechanical braking force when the electrical feedback from the wheel hub motor is not sufficient. The brake can be a hydraulic concentric brake cylinder (CBC). However, the wheel-leg mechanism is not limited to a CBC brake; instead, any known hydraulic and/or mechanical brake caliper with rotor can be used, which is compact and produces a high braking force.

Preferably, the rotary drive comprises a crank which is drivingly connected to the first joint. The crank is preferably designed as a crank shaft. The crank can be connected to the drive shaft of the rotary drive in a rotationally fixed manner or can form the drive shaft. A drive power of the rotary drive is transmitted via the crankshaft to the pantograph coupling limb assembly, specifically to the first joint, which is designed such that an angular position between the second and third coupling limbs is changed. This simultaneously changes the angular position of the coupling limbs, which are also articulatedly coupled to one another, such that the position of the wheel hub motor located at the end of the first coupling limb changes relative to the rotary drive, and thus also relative to the chassis. Thus, the crank converts a rotational movement of the rotary drive into a circular sequence of movements at the first joint or the actuating joint of the pantograph coupling limb assembly.

Preferably, the crank is drivingly connected to the first joint of the pantograph coupling limb assembly via a crank pin. The crank pin connects the pantograph coupling limb assembly with the rotary drive and the crank. The crank pin serves as a drive joint for the biaxially extensible and retractable wheel-leg mechanism, whereby the rotary drive provides information about the movement sequence of the wheel-leg mechanism and the respective position of the coupling limbs. The crank pin can be arranged eccentrically to the crank, whereby the crank pin can be operatively connected to the crank or the rest of the rotary drive via a transmission stage. A concentric assembly is also conceivable. The crank pin is arranged coaxially to the first joint. By changing the connection angle of the crank of the rotary drive to the crank pin, the mechanics of the pantograph coupling limb assembly, in particular the trajectory on which the wheel hub motor moves when the rotary drive is actuated, can be changed.

A vehicle according to the disclosure according to a first aspect of the disclosure comprises at least one biaxially extensible and retractable wheel-leg mechanism according to the first aspect of the disclosure, wherein the respective wheel-leg mechanism is arranged and supported on a common chassis. Preferably, multiple wheel-leg mechanisms according to the first aspect of the disclosure are connected to the chassis in order to provide a vehicle that can be used for different applications. The vehicle can in particular be designed as a so-called AMR (Autonomous Mobile Robot), on which goods can be transported, for example. An AMR is an intelligent vehicle that can move autonomously and without external support in its environment.

The vehicle preferably comprises a control device which is designed to control multiple wheel-leg mechanisms separately such that a position of the wheel hub motor relative to the rotary drive of the respective wheel-leg mechanism can be adjusted in the longitudinal direction and/or in the vertical direction of the vehicle. Each wheel-leg mechanism can be controlled separately by the control device. For this purpose, the control device can also communicate with sensors that record information about the environment, the operating state, the position of the vehicle or the like and provide it to the control device for evaluation, so that the vehicle, in particular the respective wheel-leg mechanism, can be controlled accordingly depending on this information.

The above statements, examples and definitions of technical effects, advantages and embodiments of the wheel-leg mechanism according to the disclosure according to the first aspect of the disclosure also apply mutatis mutandis to the vehicle according to the disclosure according to the second aspect of the disclosure, and vice versa.

### BRIEF DESCRIPTION OF THE DRAWINGS

Further measures to improve the disclosure are further described below together with a description of a preferred example of the disclosure using the figures, whereby identical or similar components are marked with the same reference sign. In the drawings:

FIG. 1 shows a simplified schematic view of a vehicle according to the disclosure with four biaxially extensible and retractable wheel-leg mechanisms according to the disclosure,

FIG. 2 shows a first schematic view of an exemplary wheel-leg mechanism according to FIG. 1,

FIG. 3 shows a second schematic view of the wheel-leg mechanism according to the disclosure according to FIG. 1 and FIG. 2,

FIG. 4 shows an exploded view of the wheel-leg mechanism according to the disclosure according to FIGS. 1 to 3,

FIG. 5 shows a representation of a first movement sequence of the wheel-leg mechanism according to the disclosure according to FIGS. 1 to 4,

FIG. 6 shows a representation of a second movement sequence of the wheel-leg mechanism according to the disclosure according to FIGS. 1 to 5, and

FIG. 7 shows a representation of a third movement sequence of the wheel-leg mechanism according to the disclosure according to FIGS. 1 to 6.

### DETAILED DESCRIPTION

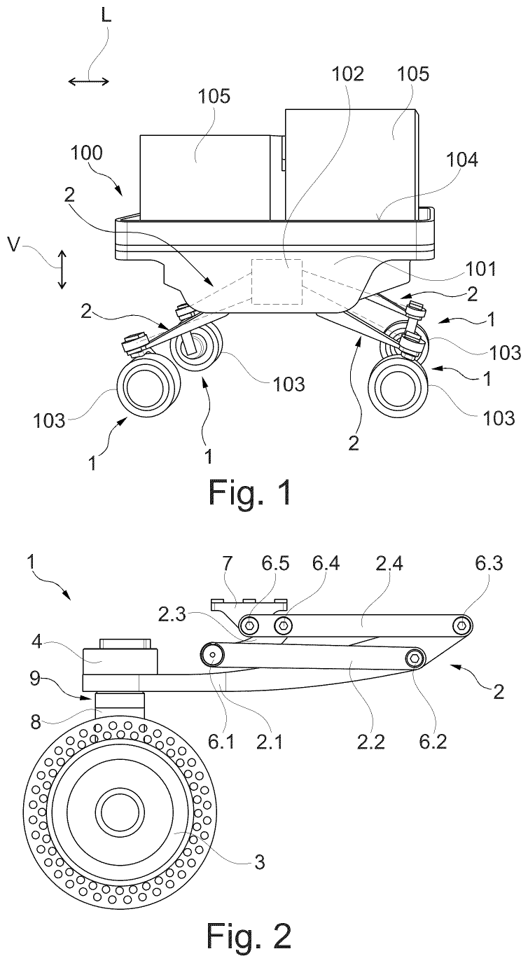

FIG. 1 shows a vehicle 100 according to the disclosure in a highly simplified manner. The vehicle 100 comprises a chassis 101 with a platform 104, wherein four inventive, biaxially extensible and retractable wheel-leg mechanisms 1 are arranged and supported on the chassis 101, with one wheel-leg mechanism 1 at each corner of the chassis 101. The vehicle 100 is an AMR, wherein the wheel-leg mechanisms 1 are designed such that a holonomic movement of the vehicle 100 is possible. The vehicle 100 comprises a control device 102 which is configured to communicate with the wheel-leg mechanisms 1 and to control them separately in such a way that a position of a respective wheel 103 relative to the chassis 101 in the longitudinal direction or in the vertical direction of the vehicle 100 can be adjusted and that a holonomic movement of the vehicle 100 takes place. With such a vehicle 100, for example, goods 105 can be transported, which can be positioned on the platform 104.

FIGS. 2 to 4 show one of the wheel-leg mechanisms 1 of the vehicle 100 as an example, the other three wheel-leg mechanisms 1 being designed identically. Therefore, all statements regarding the wheel-leg mechanism 1 described below apply equally to the three other wheel-leg mechanisms 1. In any event, the wheel-leg mechanisms 1 are oriented substantially parallel to the longitudinal axis L of the vehicle 100, two directed forwards and two oppositely directed rearwards.

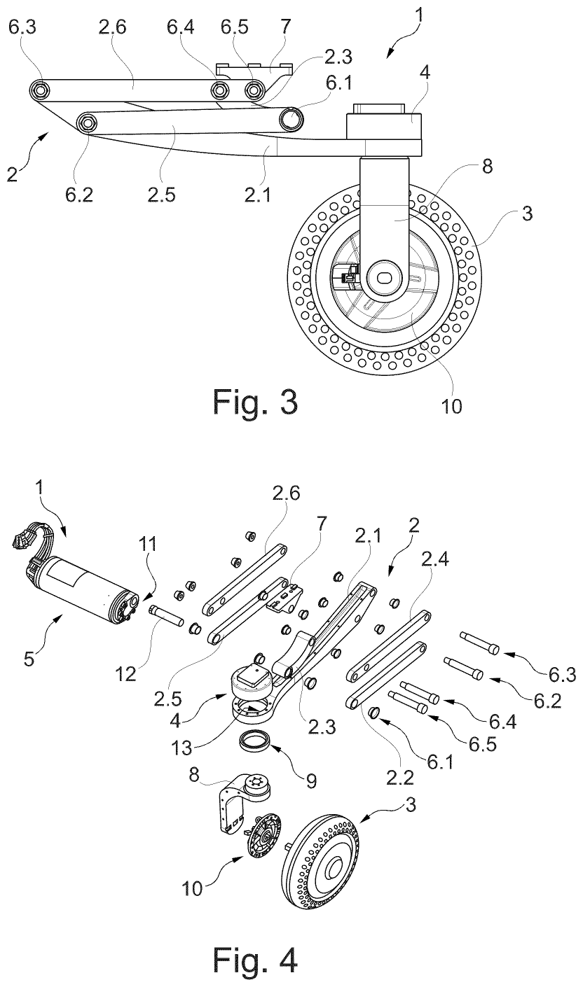

According to FIGS. 2 to 4, the wheel-leg mechanism 1 comprises a pantograph coupling limb assembly 2 with multiple coupling limbs 2.1-2.6 which are coupled together in an articulated manner. In the present case, a first coupling limb 2.1 is the longest coupling limb of the pantograph coupling limb assembly 2 shown here as an example, wherein one end of the first coupling limb 2.1 forms the lowest point of the pantograph coupling limb assembly 2 in the vertical direction. At this point or end of the first coupling limb 2.1, a steering actuator 4 is arranged in a circular recess 13 (see FIG. 4), which is connected via a stator element 8 to a hub motor 3 of a wheel hub motor—not shown here. The wheel hub motor is drivingly connected to the respective wheel 103 according to FIG. 1 in order to drive the vehicle 100. The wheel hub motor is connected for control purposes to the control device 102 according to FIG. 1. The stator element 8 can be rotated about its longitudinal axis via the steering actuator 4, so that a steering angle of the wheel 103 of the vehicle 100 can be adjusted. The stator element 8 and the steering actuator 4 are rotatably mounted relative to the pantograph coupling limb assembly 2 by means of a bearing element 9 designed as a double-row angular contact ball bearing and are supported thereon. A brake 10 is also arranged on the wheel hub motor 3 in order to generate a braking force for decelerating the vehicle 100. The brake 10 is shown in FIG. 3 and FIG. 4, but a more detailed illustration is omitted for the sake of simplicity.

In addition to the first coupling limb 2.1, the pantograph coupling limb assembly 2 has five further coupling limbs 2.2-2.6. A second, third and fifth coupling limb 2.2, 2.3, 2.5 are connected to each other via a first joint 6.1. The second and fifth coupling limbs 2.2, 2.5 are mirror images of each other and spatially accommodate the third coupling limb 2.3 at the first joint 6.1 and the fourth coupling limb 2.4 at a fourth joint 6.4. The first coupling limb 2.1 is articulatedly connected to the second and fifth coupling limbs 2.2, 2.5 at a second joint 6.2 and to the third and sixth coupling limbs 2.3, 2.6 at a third joint 6.3, which in this case is arranged at the other end of the first coupling limb 2.1. The third and sixth coupling limbs 2.3, 2.6 are mirror images of each other and accommodate the first coupling limb 2.1 at the third joint 6.3 and the third coupling limb 2.3 at the fourth joint 6.4 between them. The first coupling limb 2.1 is articulatedly coupled to the second coupling limb 2.2 and the fourth coupling limb 2.3, whereby the third coupling limb 2.3 is articulatedly coupled to the second and fourth coupling limbs 2.2, 2.4. Likewise, the first coupling limb 2.1 is articulatedly coupled to the fifth coupling limb 2.5 and the sixth coupling limb 2.6, whereby the third coupling limb 2.3 is also articulatedly coupled to the fifth and sixth coupling limbs 2.5, 2.6.

The fifth and sixth coupling limbs 2.5, 2.6 serve only to ensure the stability of the wheel-leg mechanism 1. The system of the wheel-leg mechanism 1 also functions if the two coupling limbs 2.5 and 2.6 are omitted. At a fifth joint 6.5, a chassis bracket 7 is arranged at one end of the fourth coupling limb 2.4, which is designed to fasten the wheel-leg mechanism 1 to the chassis 101 of the vehicle 100. The coupling limbs 2.1-2.6 and the joints 6.1-6.5 are shown in the exploded view of FIG. 4. The joints 6.1-6.5 are realized by bolts with flanged bushings, each of which has a friction-reducing effect on the interconnected coupling limbs. For the sake of simplicity, a more detailed description and explanation of joints 6.1-6.5 is omitted here. In any case, the joints 6.1-6.5 are designed in such a way that the coupling limbs 2.1-2.6 are articulatedly coupled to each other with low friction. In the context of this disclosure, an articulated coupling is understood to mean that the coupling limbs 2.1-2.6 are freely rotatably connected to one another around the respective joint 6.1-6.5 in a plane that is arranged perpendicular to the longitudinal axis of the joint 6.1-6.5. Only the first joint 6.1 or the actuating joint is designed such that it carries out a targeted pivoting of the third coupling limb 2.3 to the second or fifth coupling limb 2.2, 2.5 by driving the rotary drive 5.

In the present case, the first joint 6.1 is to be understood as an actuating joint, via which a change in the position of the coupling limbs 2.1-2.6, which are coupled together in an articulated manner, relative to one another takes place. A rotary drive 5 shown in FIG. 4 with a crank 11 and a crank pin 12 is drivingly arranged on the first joint 6.1. The rotary drive 5 is an electrical machine which generates a drive power and transmits it to the crank 11 via a rotor of the rotary drive 5 (not shown here). The crank pin 12 can be arranged coaxially or axially parallel to the crank 11 via a transmission stage. The rotary drive 5 is provided for positioning the coupling limbs 2.1-2.6, wherein the control device 102 according to FIG. 1 is designed to obtain information about the current position of the coupling limbs 2.1-2.6 based on the position of the crank 11. For this purpose, information on the design and mechanics of the pantograph coupling limb assembly 2 for each angular position of the rotary drive 5, in particular of the crank 11, is stored on the control device 102. In other words, the control device 102 knows, in each angular position of the rotary drive 5 or the crank 11, how the coupling limbs 2.1-2.6 are positioned relative to one another and, accordingly, also in which position the wheel hub motor 3 is located relative to the rotary drive 5 and the chassis 101 of the vehicle 100.

Accordingly, the rotary drive 5 is designed to set an relative angular position between the coupling limbs 2.1-2.4, coupled together in an articulated manner, such that a position of the wheel hub motor 3 relative to the rotary drive 5 can be adjusted in the longitudinal direction and/or in the vertical direction of the vehicle 100, so that the control device 102 can influence driving-specific situations of the vehicle 100.

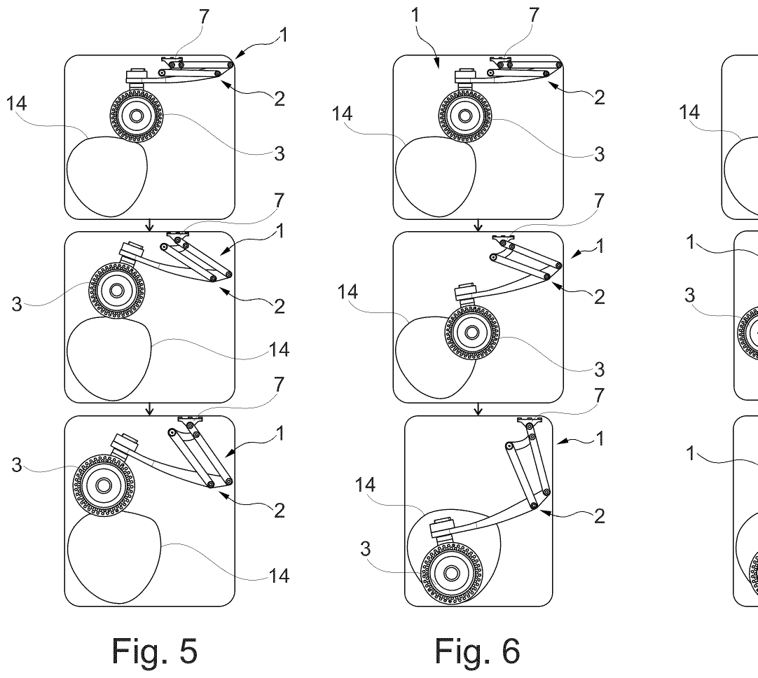

By means of the pantograph coupling limb assembly 2, a rotational movement of the crank 11 or the crank pin 12 at the first joint 6.1 is converted by the rotary drive 5 into a movement of the wheel hub motor 3 along a gear trajectory that depends on the design of the pantograph coupling limb assembly 2 and the connection of the rotary drive 5. The gear trajectory is a sequence of movements of the wheel hub motor 3 which it executes during the actuation of the rotary drive 5, wherein the wheel hub motor 3 moves in the longitudinal direction and/or in the vertical direction to the chassis 101 of the vehicle 100. This is shown in FIGS. 5 to 7, with the gear trajectory 14 shown in the bottom left of each frame as a rectangle with rounded corners. The wheel hub motor 3 moves along the gear trajectory 14 shown when the crank 11 is set in rotation and this movement is converted into a pivoting of the coupling limbs 2.1-2.6 relative to each other. Depending on the direction of rotation of the rotary drive 5, a position of the wheel hub motor 3 relative to the rotary drive 5 can be adjusted in the longitudinal direction L and/or in the vertical direction V of the vehicle 100.

In FIGS. 5 to 7, the wheel-leg mechanism 1 is shown in the upper of the three figures in a normally retracted position, analogous to FIG. 2 and FIG. 3. The wheel-leg mechanisms 1 shown here relate to the wheel-leg mechanism 1 described in FIG. 2 to FIG. 4. The three images shown vertically one below the other in FIGS. 5 to 7 show a respective sequence of movements of the wheel hub motor 3 when the rotary drive 5 is actuated.

If the rotary drive 5 is driven in a first direction of rotation, the pantograph coupling limb assembly 2 is adjusted such that the wheel hub motor 3 pivots counterclockwise along the trajectory 14, see middle and lower illustrations of FIG. 5. Thus, the wheel hub motor 3 is adjusted in a forward direction substantially along the longitudinal axis L of the vehicle 100. This can be done up to an end position, for example as far as the wheel hub motor 3 moves substantially along the longitudinal axis L of the vehicle 100. Therefore, the wheel hub motor 3 only follows the trajectory 14 in an anti-clockwise direction for part of its circumference.

If the rotary drive 5 is driven in a second direction of rotation counter to the first direction of rotation, the pantograph coupling limb assembly 2 is adjusted such that the wheel hub motor 3 pivots clockwise along the trajectory 14, see middle and lower illustrations of FIG. 6. Thus, the wheel hub motor 3 is adjusted in a downwards direction substantially along the vertical axis V of the vehicle 100. This can also be done up to an end position, for example as far as the wheel hub motor 3 moves substantially perpendicular to the longitudinal axis L or along the vertical axis V of the vehicle 100. Therefore, the wheel hub motor 3 only follows the trajectory 14 in the clockwise direction for part of its circumference.

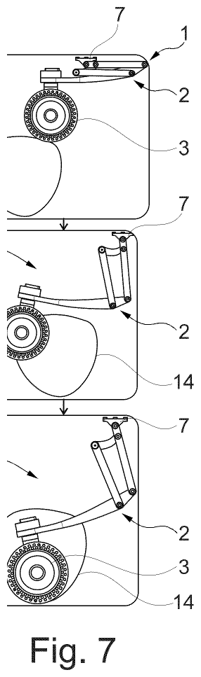

FIG. 7 is intended to illustrate that the rotary drive 5 can also be designed to be rotatable by 360°, so that the wheel hub motor 3 follows the entire trajectory 14 either counterclockwise or clockwise. This makes it possible to realize a diagonal or partly forward-moving and partly vertical movement sequence of the wheel hub motor 3 along the longitudinal axis L and the vertical axis V of the vehicle 100.

Of course, it is conceivable to operatively arrange the rotary drive 5 on any other of the joints 6.2 to 6.5. The connection at the first joint 6.1 is to be understood as an example only. Likewise, the steering actuator 4 and the wheel hub motor 3 can be arranged on any other coupling limb 2.2-2.6.

### LIST OF REFERENCE SIGNS

1 Wheel-leg mechanism
2 Pantograph coupling limb assembly
2.1-2.6 Coupling limbs
3 Wheel hub motor
4 Steering actuator
5 Rotary drive
6.1-6.5 Joint
7 Chassis bracket
8 Stator element
9 Bearing element
10 Brake
11 Crank
12 Crank pins
13 Recess on the first coupling limb
14 Gear trajectory or trajectory
100 Vehicle
101 Chassis
102 Control device
103 Wheel
104 Platform
L Longitudinal axis or longitudinal direction of the vehicle
V Vertical axis or vertical direction of the vehicle

1. A biaxially extensible and retractable wheel-leg mechanism for a vehicle, comprising a pantograph coupling limb assembly with multiple coupling limbs which are coupled together in an articulated manner, wherein a wheel hub motor and a steering actuator operatively connected thereto are arranged on a first coupling limb, and the wheel hub motor is designed to rotate a vehicle wheel drivingly connected to the wheel hub motor, and wherein the steering actuator is designed to set a steering angle of the wheel of the vehicle, the wheel-leg mechanism additionally comprising a rotary drive for positioning the coupling limbs, said rotary drive being drivingly arranged on a first joint between a second coupling limb and a third coupling limb, wherein the rotary drive is designed to set a relative angular position between the coupling limbs coupled together in an articulated manner such that a position of the wheel hub motor relative to the rotary drive can be adjusted in the a longitudinal direction and/or in the a vertical direction of the vehicle.

2. The wheel-leg mechanism according to claim 1, wherein the pantograph coupling limb assembly comprises at least four coupling limbs, wherein the first coupling limb is articulatedly coupled to the second coupling limb and a fourth coupling limb, and wherein the third coupling limb is articulatedly coupled to the second and fourth coupling limbs.

3. The wheel-leg mechanism according to claim 2, further comprising a chassis bracket which is arranged on the fourth coupling limb and is designed to fasten the wheel-leg mechanism to a chassis of the vehicle.

4. The wheel-leg mechanism according to claim 1, wherein the wheel hub motor and the steering actuator are connected to one another via a stator element which is radially and axially mounted on the first coupling limb via a bearing element.

5. The wheel-leg mechanism according to claim 4, wherein the bearing element is a double-row angular contact ball bearing.

6. The wheel-leg mechanism according to claim 1, wherein a brake is arranged on the wheel hub motor.

7. The wheel-leg mechanism according to claim 1, wherein the rotary drive comprises a crank which is drivingly connected to the first joint.

8. The wheel-leg mechanism according to claim 7, wherein the crank is drivingly connected to the first joint of the pantograph coupling limb assembly via a crank pin.

9. A vehicle comprising at least one biaxially extensible and retractable wheel-leg mechanism according to claim 1, wherein the respective wheel-leg mechanism is arranged and supported on a common chassis.

10. The vehicle according to claim 9, further comprising a control device which is designed to control multiple wheel-leg mechanisms separately such that a position of the wheel hub motor relative to the rotary drive of the respective wheel-leg mechanism can be adjusted in the longitudinal direction and/or in the vertical direction of the vehicle.
